(19) United States
(12) Patent Application Publication
(10) Pub. No.: US 2025/0252035 A1
(43) Pub. Date: Aug. 7, 2025

(54) Automated Testing based on Intelligent Exploration

(71) Applicant: Microsoft Technology Licensing, LLC, Redmond, WA (US)

(72) Inventors: Shaopeng BU, Beijing (CN); Yingjie LI, Suzhou (CN); Hong DING, Beijing (CN); Ran TAO, Beijinng (CN); Le ZHOU, Suzhou (CN); Xiaoyi ZHANG, Beijing (CN); Yuwang WANG, Beijing (CN)

(21) Appl. No.: 18/855,608

(22) PCT Filed: Apr. 12, 2023
(86) PCT No.: PCT/US2023/018224

§ 371 Date: Oct. 9, 2024

(30) Foreign Application Priority Data
May 25, 2022 (CN) 202210581034.9

(51) Int. Cl. G06F 11/3668; G06F 11/3698

(52) U.S. Cl. CPC G06F 11/3684; G06F 11/3688; G06F 11/3698

(57) ABSTRACT

The present disclosure proposes a method, apparatus and computer program products for automated testing based on intelligent exploration. A user interface of a target application may be obtained. A user interface representation of the user interface may be generated. An action for the user interface may be determined based on the user interface representation. Automated testing may be performed on the target application through applying the action to the user interface to explore a next user interface.

### BACKGROUND

In the development process of software applications, testing plays a very critical role as an extremely important part of ensuring application quality. Herein, a software application for which testing is performed may be referred to as a target application. Usually, when testing a target application, after a testing case is determined, a tester may perform testing step by step according to a procedure described in the testing case, and compare actual testing results with expected testing results, to verify whether functions of the target application are correct. In this process, in order to save manpower, time or hardware resources, and improve testing efficiency, automated testing is introduced. Automated testing may be a process of transforming a human-driven testing into a machine-executed testing. In automated testing, specific softwares or programs may be utilized to control the performing of testing and the comparison between actual testing results and expected testing results. Through the automated testing, some repetitive but necessary testing tasks that exist in the testing process may be automated, or some testing tasks that are otherwise difficult to perform manually may be performed.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter. Embodiments of the present disclosure propose a method, apparatus and computer program product for automated testing based on intelligent exploration. A user interface of a target application may be obtained. A user interface representation of the user interface may be generated. An action for the user interface may be determined based on the user interface representation. Automated testing may be performed on the target application through applying the action to the user interface to explore a next user interface.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary architecture for an automated testing system according to an embodiment of the present disclosure.

FIG. 2 illustrates an example of exploring among multiple user interfaces of a target application according to an embodiment of the present disclosure.

FIG. 3 illustrates an exemplary intelligent testing performing unit according to an embodiment of the present disclosure.

FIG. 4 illustrates an exemplary process for training an action decision model during performing intelligent testing according to an embodiment of the present disclosure.

FIG. 5 illustrates an exemplary process for automated testing based on intelligent exploration according to an embodiment of the present disclosure.

FIG. 6 is a flowchart of an exemplary method for automated testing based on intelligent exploration according to an embodiment of the present disclosure.

FIG. 7 illustrates an exemplary apparatus for automated testing based on intelligent exploration according to an embodiment of the present disclosure.

FIG. 8 illustrates an exemplary apparatus for automated testing based on intelligent exploration according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Existing automated testing services usually require testers to provide testing cases. A testing case may include a series of testing steps to be performed on a target application. The testing case is usually pre-compiled for the target application by specialized software testers or software developers. This requires consuming a large amount of time. Additionally, if the target application is updated or upgraded, the testing case needs to be modified or recompiled for the new target application, which is also time-consuming. These aspects restrict the efficiency of the automated testing. Moreover, the existing automated testing services may also provide Monkey testing when users do not provide testing cases. Monkey testing may also be referred to as funny testing. Monkey testing may perform a series of random actions on a target application, to verify the stability of the target application. However, the Monkey testing may not be able to decide which action makes sense for a current user interface of the target application, since it does not know what the current user interface is. Also, the random actions provided by the Monkey testing may cause the target application to loop through several user interfaces, while other user interfaces are not involved. Additionally, many target applications include login interfaces, and the Monkey testing often skips the login interfaces without testing them. The above defects in the Monkey testing may make it difficult to test the target application accurately and comprehensively.

Embodiments of the present disclosure propose automated testing based on intelligent exploration. The automated testing based on intelligent exploration aims to automatically determine an action for a user interface of a target application based on understanding of the user interface. When the action is applied to the user interface, a next interface of the target application may be triggered. Through continuously determining and applying actions, the user interfaces of the target application can be explored, to identify bugs or fault existing in the target application. Herein, the automated testing based on intelligent exploration may also be referred to as intelligent testing for short. The automated testing based on intelligent exploration may perform automated testing on the target application without pre-compiling testing cases. Additionally, when the target application is updated or upgraded, there is no need to modify testing cases or testing programs even if the user interfaces change significantly. This may greatly improve the efficiency of automated testing. Furthermore, compared to perform automated testing by use of Monkey testing, the automated testing based on intelligent exploration may apply an action, to a user interface, suitable for the user interface based on understanding of the user interface, which facilitates implementing high-quality automated testing.

In an aspect, the embodiments of the present disclosure propose to intelligently understand a user interface of a target application through machine learning techniques. For example, screen image and layout information of a user interface may be extracted first. Layout information of a user interface may include, e.g., a set of interface elements included in the user interface, a property of each interface element in the set of interface elements, etc. Then, the extracted screen image and layout information may be provided to a user interface encoding model. The user interface encoding model may be, e.g., a machine learning model based on a transformer structure. The user interface encoding model may encode the screen image and layout information of the user interface, to generate a user interface representation of the user interface. After the user interface representation of the user interface is obtained, a scenario category corresponding to the user interface may be further identified through a scenario classification model. The scenario classification model may be, e.g., a machine learning model capable of performing a multi-class task. A set of scenario categories may be predefined, and the set of scenario categories may include, e.g., a login scenario, a video playing scenario, an information filling scenario, a search scenario, a setting scenario, etc. The scenario classification model may identify a scenario category corresponding to the user interface, from the set of predefined scenario categories, based on the user interface representation of the user interface. A user interface may be fully understood through generating a user interface representation of the user interface and identifying a scenario category corresponding to the user interface with machine learning techniques, which facilitates subsequent accurate determination of an action for the user interface.

In another an aspect, the embodiments of the present disclosure propose to automatically determine actions for a user interface of a target application through a variety of approaches. For each scenario category in some scenario categories, a rule for the scenario category may be preset. The rule may include an action appropriate to the scenario category. When a scenario category corresponding to the user interface is identified, it may be determined whether there is a rule for the scenario category. If it is determined that there is a rule for the scenario category, an action corresponding to the rule may be obtained, and the obtained action is determined as an action for the user interface. This approach may be considered as a rule-based approach. This approach may cause the target application to enter a specific scenario in depth, thereby in-depth testing may be performed for the specific scenario. In particular, a rule for a login scenario may be preset, so that in-depth testing may be performed for the login scenario. This cannot be implemented by the Monkey testing. If there is no rule for the scenario category, an action for the user interface may be predicted through an action decision model. The action decision model may be, e.g., a machine learning model based on reinforcement learning. The action decision model may consider the target application as an environment, a user interface representation and a scenario category of a current user interface of the target application as a current state of the environment, and predict an action for the user interface based on the current state. A reward corresponding to the action may be calculated, and may be used to update or further train the action decision model. A user interface may include a set of interface elements. Each interface element may have a corresponding operation mode. Herein, an operation mode of an interface element may refer to operations that can be performed on the interface element, e.g., clicking, long pressing, typing, scrolling, etc. Through an action decision model, a set of operation probabilities corresponding to the set of interface elements may be generated based on the user interface representation and the scenario category, and an interface element to be operated may be identified from the set of interface elements based on the set of operation probabilities. The identified interface element and the operation mode corresponding to the identified interface element may be used to define an action for the user interface. This approach may be considered as a model-based approach. Since the identification of the interface element to be operated is based on the operation probabilities generated by the action decision model, the identified interface element and the corresponding determined action may have certain randomness while ensuring pertinence. This may enable the target application to traverse more user interfaces, thereby the target application may be tested broadly. Through combining both the rule-based approach and the model-based approach for determining an action for a user interface of a target application, the coverage and integrity of automated testing may be improved in both depth and breadth.

In yet another aspect, the embodiments of the present disclosure propose to design a reward function for training an action decision model based on a user interface triggered by an action. An action that triggers an abnormal user interface may have a first reward. For example, when an action is applied and the user interface crashes, the action may be considered to trigger an abnormal user interface. An action that triggers a normal and unexplored user interface may have a second reward. For example, when an action is applied and a previously unexplored or not occurred user interface presents, the action may be considered to trigger a normal and unexplored user interface. An action that triggers a normal and explored user interface may have a third reward. For example, when an action is applied and a previously explored or occurred user interface represents, the action may be considered to trigger a normal and explored user interface. Preferably, a specific value of the third reward may be determined based on the number of times the user interface occurs. An action that stalls a user interface may have a fourth reward. For example, when an action is applied but the user interface does not change, the action may be considered to stall the user interface. Values of the first reward, the second reward, the third reward and the fourth reward may decrease in sequence. Such a reward function may enable the action decision model to predict an action that enables the target application to present an abnormal or unexplored user interface, thereby as many different user interfaces as possible can be explored during the automated testing. This facilitates to improve the coverage of the automated testing, detect the stability of the target application, and enable problems of the target application to be exposed during the testing.

In still another aspect, the embodiments of the present disclosure propose pretraining an action decision model through a teaching mode before the action decision model is deployed for performing intelligent testing. For example, a set of teaching actions may be set. Each teaching action of the set of teaching actions may have a high reward, e.g., a reward above a predetermined reward threshold. An action may be defined with an interface element and an operation mode corresponding to the interface element. An interface element corresponding to the teaching action may have a high operation probability. The action decision model may be pretrained with the set of teaching actions and a set of rewards corresponding to the set of teaching actions. Training an action decision model with such teaching actions will help the action decision model learn what action can obtain a high reward, and thus, when deployed to perform intelligent testing, will be able to predict a high-quality action with a high reward.

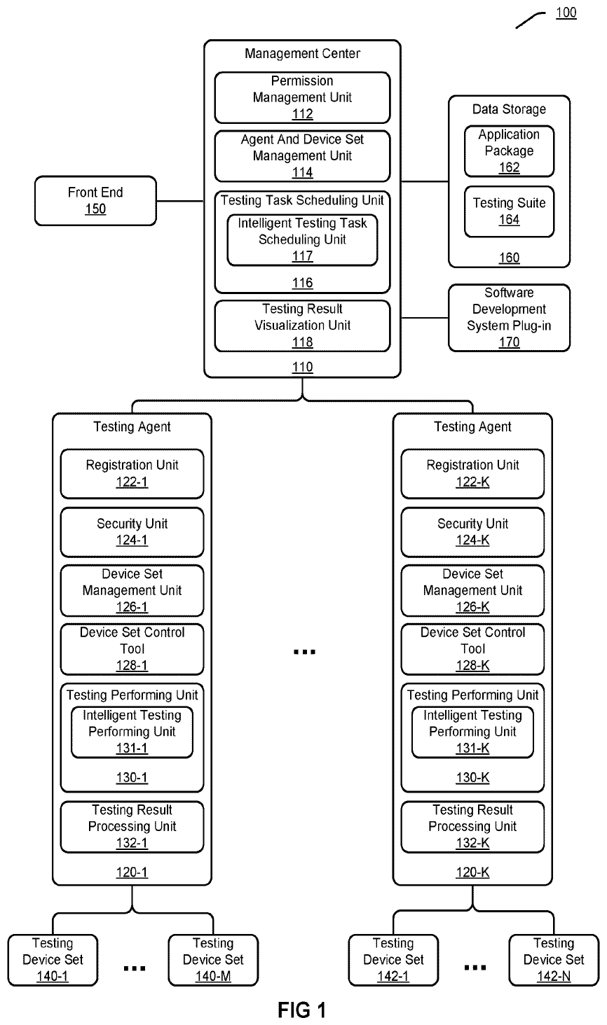

FIG. 1 illustrates an exemplary architecture 100 for an automated testing system according to an embodiment of the present disclosure. The architecture 100 may provide an automated testing service for a target application, e.g., an automated testing service based on intelligent exploration for a target application according to an embodiment of the present disclosure. The target application may include, e.g., a mobile application running on a mobile device, a computer application running on a desktop computer or a portable computer, etc. The architecture 100 may include a management center 110 and at least one testing agent, e.g., a testing agent 120-1 to a testing agent 120-K (K≥1). Additionally, the architecture 100 may also include at least one testing device set. Each testing device set may be associated with one of the at least one testing agents. For example, a testing device set 140-1 to a testing device set 140-M (M≥1) may be associated with the testing agent 120-1, and a testing device set 142-1 to a testing device set 142-N (N≥1) may be associated with the testing agent 120-K, where N may be equal to or not equal to M. Each testing device set may have various forms, e.g., a single testing device, a testing device pair consisting of two testing devices, and a testing device group consisting of more than two testing devices, etc. Each testing device set may be configured to run a target application. A single testing device may be used to perform automated testing for a target application independently. A testing device pair and a testing device group may be used to perform automated testing for a target application collaboratively.

The management center 110 may manage testing agents, schedule testing tasks, visualize testing results, etc. The management center 110 may be deployed in the cloud. It should be appreciated that although only one management center 110 is shown in the architecture 100, in some embodiments, the management center may be scalable. For example, an automated testing system may include more than one management center. These management centers may be managed as a management center cluster with unified endpoints. Each management center in the management center cluster may be deployed on multiple nodes in a distributed way, to avoid single node failure. The management center 110 may be connected to a front end 150. The front end 150 may interface with users, and present a user interface associated with the management center 110 to the users. Additionally, the management center 110 may be connected to a data storage 160. The data storages 160 may be deployed in the cloud. The data storage 160 may store testing resources, e.g., an application package 162, a testing suite 164, etc. The application package 162 may include applications for installing and running target applications. The testing suite 164 may include a testing case uploaded by a user, a program for performing Monkey testing, a program for performing intelligent testing, etc. The management center 110 may manage the testing resources stored in the data storage 160. Additionally, the management center 110 may be connected to a software development system plug-in 170. The software development system plug-in 170 may be used to integrate automated testing service with a software development system.

The management center 110 may include a permission management unit 112. The permission management unit 112 may manage a permission of a testing agent. For example, the permission management unit 112 may determine whether to register a terminal device to configure the terminal device as a testing agent when receiving a registration request from the terminal device. The registration request may be triggered by a testing agent creating program running on the terminal device. Additionally, the permission management unit 112 may manage a permission of a user, to determine a testing device set that the user can use.

The management center 110 may include an agent and device set management unit 114. The agent and device set management unit 114 may be used to manage testing agents registered to the management center 110 and testing device sets associated with the testing agents. Status of the testing agents and/or testing devices in the testing device sets may be presented to users via the front end 150.

The management center 110 may include a testing task scheduling unit 116. The testing task scheduling unit 116 may generate a testing task corresponding to a testing request, and schedule the testing task to a corresponding testing agent. For example, a testing request might specify a testing device set with which to perform automated testing. The testing task scheduling unit 116 may schedule a testing task corresponding to the testing request to a testing agent associated with the testing device set specified in the testing request. In particular, the testing task scheduling unit 116 may include an intelligent testing task scheduling unit 117. When a testing request indicates that intelligent testing is to be performed, the intelligent testing task scheduling unit 117 may schedule a configuration file for performing the intelligent testing, e.g., rules and corresponding actions for some scenario categories, a machine learning model to be called, and a teaching mode used to train an action decision model, etc.

The management center 110 may include a testing result visualization unit 118. The testing result visualization unit 118 may visualize a testing result of automated testing. The testing result of the automated testing may include, e.g., pass/fail information, running time, testing log, device log, customized log screenshot, performance data, etc., corresponding to each testing case.

Each testing agent 120-k (1≤k≤K) of the testing agent 120-1 to the testing agent 120-K may be registered to the management center 110. The management center 110 and the testing agent 120-k may access each other through, e.g., Remote Procedure Call. The testing agent 120-k may be created from any computing device located at any geographic location. The testing agent 120-K may perform testing tasks, send testing results to the management center 110, etc.

The testing agent 120-k may include a registration unit 122-k for initiating a registration process with the management center 110.

The testing agent 120-k may include a security unit 124-k for determining whether to perform a testing task scheduled by the management center 110. For example, the security unit 124-k may analyze a testing task received from the management center 110, determine whether the received testing task includes an authorization code of a corresponding specified testing device set, and if so, notify the testing agent 120-k, e.g., a testing performing unit 130-k in the testing agent 120-k, to perform the automated testing.

The testing agent 120-k may include a device set management unit 126-k for locally managing one or more testing device sets associated therewith.

The testing agent 120-k may include a device set control tool 128-k for controlling and debugging one or more testing device sets associated therewith. The testing agent 120-k is typically associated with one type of testing device set. The device set control tool 128-k may, e.g., correspond to the type of testing device set associated with the testing agent 120-k. As an example, when the testing device set associated with the testing agent 120-k is an Android device, the device set control tool 128-k may be a software development kit (SDK) for Android device. As another example, when the testing device set associated with the testing agent 120-k is an iOS device, the device set control tool 128-k may be a SDK for iOS device.

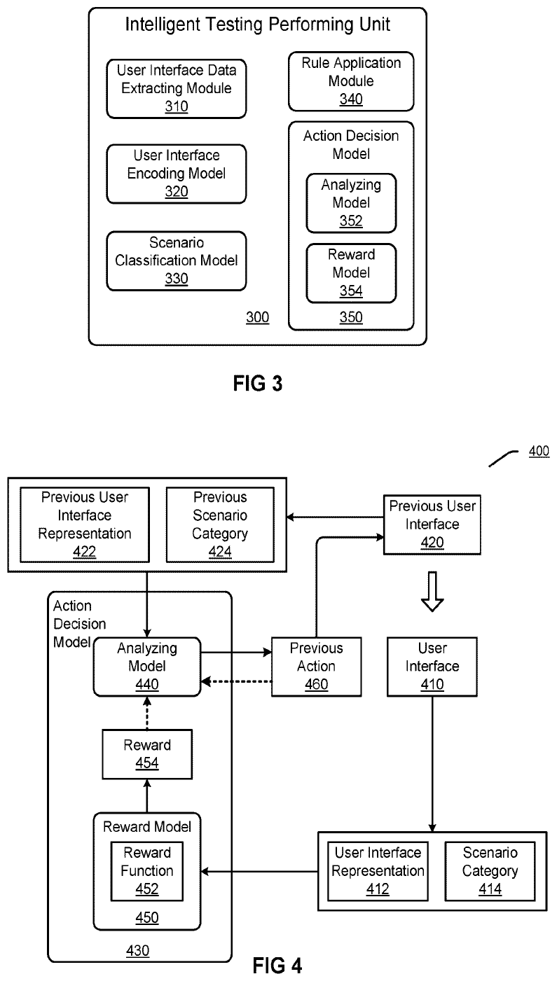

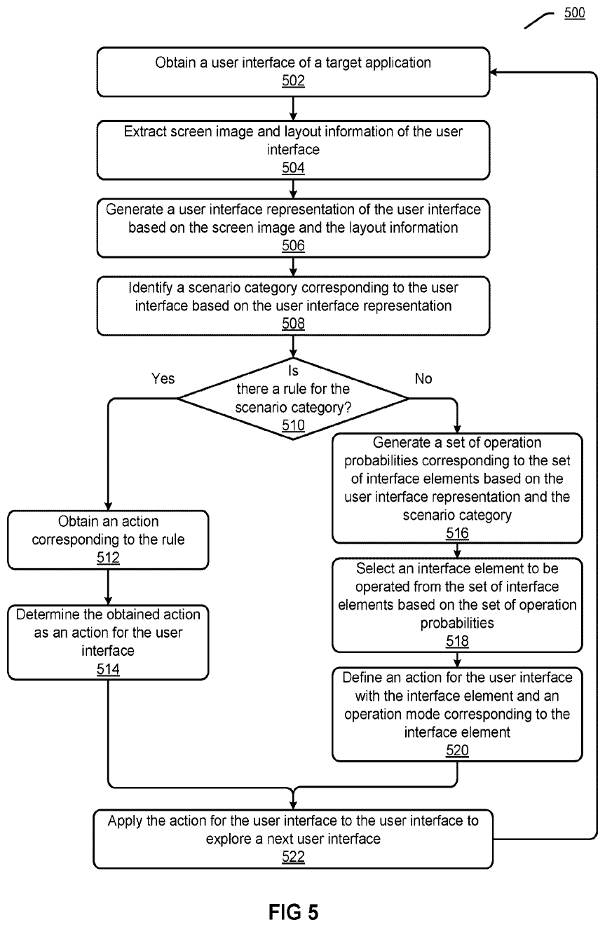

The testing agent 120-k may include a testing performing unit 130-k for performing automated testing with a testing device set, a testing suite, etc. specified in a testing task. In particular, the testing performing unit 130-k may include an intelligent testing performing unit 131-k. Automated testing based on intelligent exploration according to the embodiments of the present disclosure may be performed through the intelligent testing performing unit 131-k. An exemplary structure of the intelligent testing performing unit 131-k will be described later in conjunction with FIG. 3, and an exemplary process of performing automated testing based on intelligent exploration through the intelligent testing performing unit 131-k will be described in conjunction with FIG. 5. The testing agent 120-k may include a testing result processing unit 132-k for acquiring a testing result of automated testing and sending the testing result to the management center 110. It should be appreciated that the architecture shown in FIG. 1 is merely one example of the architecture of the automated testing system. Depending on actual application requirements, the automated testing system may have any other structure, and may include more or fewer component.

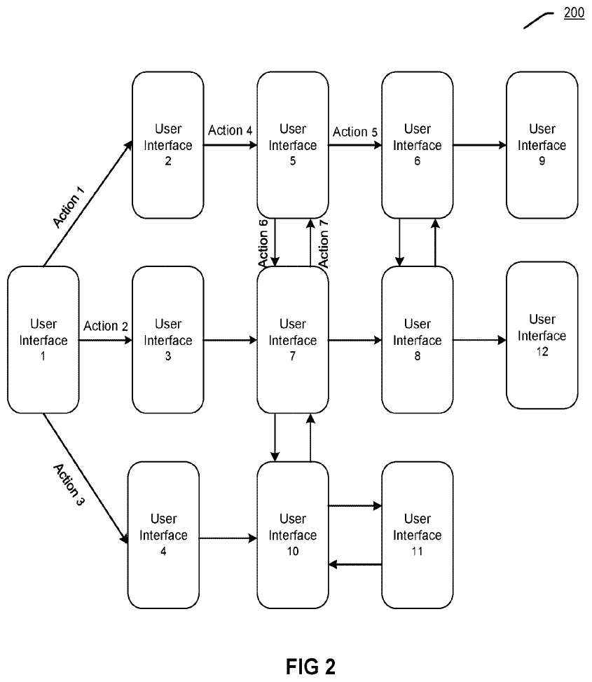

FIG. 2 illustrates an example 200 of exploring among multiple user interfaces of a target application according to an embodiment of the present disclosure.

As an example, assume that the target application has a total of 12 user interfaces, e.g., a user interface 1 to a user interface 12. These user interfaces may include an abnormal user interface, e.g., a user interface indicating that the target application has crashed. Through the automated testing process based on intelligent exploration according to the embodiments of the present disclosure, the user interfaces of the target application can be explored, and defects or faults existing in the target application may be identified. The user interface 1 may be, e.g., a launching interface of the target application, i.e., a user interface presented when the target application is launched. Applying an action 1 to the user interface 1 may trigger a user interface 2, applying an action 2 to the user interface 1 may trigger a user interface 3, and applying an action 3 to the user interface 1 may trigger a user interface 4. Each user interface may be further explored. For example, applying an action 4 to the user interface 2 may trigger a user interface 5, applying an action 5 to the user interface 5 may trigger a user interface 6, etc. Additionally, some user interfaces may be toggled back and forth. For example, applying an action 6 to the user interface 5 may trigger a user interface 7, while applying an action 7 to the user interface 7 may return to the user interface 5. An action applied to each user interface may be automatically determined in a rule-based approach or a model-based approach based on understanding of the user interface.

It should be appreciated that FIG. 2 merely shows an example of exploring among multiple user interfaces of a target application. Depending on actual application requirements, the target application may have more or less user interfaces, and these user interfaces may be explored in a process different from that shown in FIG. 2.

FIG. 3 illustrates an exemplary intelligent testing performing unit 300 according to an embodiment of the present disclosure. The intelligent testing performing unit 300 may correspond to the intelligent testing performing unit 131-k in FIG. 1. Automated testing based on intelligent exploration according to the embodiments of the present disclosure may be performed through the intelligent testing performing unit 300.

The intelligent testing executing unit 300 may include a user interface data extracting module 310.

The user interface data extracting module 310 may extract a screen image of a user interface. For example, for a specific user interface, the user interface data extracting module 310 may extract a screen image of the user interface through performing a screen capture operation on the user interface. Alternatively or additionally, the user interface data extracting module 310 may extract layout information of a user interface. Layout information of a user interface may include, e.g., a set of interface elements included in the user interface, a property of each interface element in the set of interface elements, etc. A property of an interface element may include, e.g., position, color, text content, operation mode, etc., of the interface element. An operation mode of an interface element may include, e.g., clicking, long pressing, typing, scrolling, etc. The layout information may be represented by a markup language such as Extensible Markup Language (XML).

The intelligent testing performing unit 300 may include a user interface encoding model 320. The user interface coding model 320 may be, e.g., a machine learning model based on a transformer structure. The user interface encoding model 320 may generate a user interface representation of a user interface based on screen image and/or layout information of the user interface extracted by the user interface data extracting module 310. The user interface representation may include information related to the entire user interface as well as information related to individual interface elements on the user interface.

The intelligent testing performing unit 300 may include a scenario classification model 330. The scenario classification model 330 may be, e.g., a machine learning model capable of performing a multi-class task. The scenario classification model 330 may identify a scenario category corresponding to a user interface based on a user interface representation of the user interface generated by the user interface encoding model 320. A set of scenario categories may be predefined, and the set of scenario categories may include, e.g., a login scenario, a video playing scenario, an information filling scenario, a search scenario, a setting scenario, etc. The scenario classification model 330 may identify a scenario category corresponding to the user interface, from the set of predefined scenario categories, based on the user interface representation of the user interface.

A user interface may be fully understood through generating a user interface representation of the user interface through the user interface encoding model 320 which is based on machine learning techniques and identifying a scenario category corresponding to the user interface through the scenario classification model 330 which is based on machine learning techniques, which facilitates subsequent accurate determination of an action for the user interface.

The intelligent testing performing unit 300 may include a rule application module 340. For each scenario category in some scenario categories, a rule for the scenario category may be preset. The rule may include an action appropriate to the scenario category. For example, for a login scenario, the preset rule for the scenario category may be identifying a user name input box on a user interface, inputting a user name in the identified user name input box, identifying a password input box on the user interface, inputting a password in the identified password input box, clicking a login button, etc. The user name input box and the password input box may be identified, e.g., through a text pattern matching model or a computer vision model. The input user name and password may be obtained, e.g., from a corresponding configuration file. When a scenario category corresponding to a user interface is identified through the scenario classification model 330, it may be determined whether there is a rule for the scenario category. If it is determined that there is a rule for the scenario category, an action corresponding to the rule may be obtained through the rule application module 340, and the obtained action is determined as an action for the user interface. The approach described above may be considered as a rule-based approach. This approach can cause the target application to enter a specific scenario in depth, thereby in-depth testing may be performed for the specific scenario. In particular, a rule for a login scenario may be preset, so that in-depth testing may be performed for the login scenario. This cannot be implemented by the Monkey testing.

The intelligent testing performing unit 300 may include an action decision model 350. The action decision model 350 may be, e.g., a machine learning model based on reinforcement learning, e.g., a reinforcement learning model. The action decision model 350 may consider a target application as an environment, a user interface representation and a scenario category of a current user interface of the target application as a current state of the environment, and predict an action for the user interface based on the current state. A reward corresponding to the action may be calculated, and may be used to update or further train the action decision model 350. The action decision model 350 may predict an action for a user interface based on the user interface representation of the user interface generated by the user interface encoding model 320 and/or the scenario category of the user interface identified by scenario classification model 330. For example, when a scenario category corresponding to the user interface is identified through the scenario classification model 330 and there is no rule for the scenario category, an action for the user interface may be predicted through the action decision model 350. A user interface may include a set of interface elements. Each interface element may have a corresponding operation mode, e.g., clicking, long pressing, typing, scrolling, etc. The operation mode may be included in layout information extracted through the user interface data extracting module 310, and may be embodied in a user interface representation generated by the user interface encoding model 320. In an implementation, through the action decision model 350, an interface element to be operated in a set of interface elements may be identified based on a user interface representation and/or a scenario category, and an action for the interface element may be defined with the identified interface element and an operation mode corresponding to the identified interface element. When identifying an interface element to be operated, the action decision model 350 may generate a set of operation probabilities corresponding to the set of interface elements based on the user interface representation and/or the scenario category, and select the interface element to be operated from the set of interface elements based on the generated set of operation probabilities. A probability of each interface element being selected may be proportional to an operation probability of the interface element. This approach may be considered as a model-based approach. Since the identification of the interface element to be operated is based on the operation probability generated by the action decision model, the identified interface element and the corresponding determined action may have certain randomness while ensuring pertinence. This may enable the target application to traverse more user interfaces, thereby the target application may be tested broadly.

The rule application module 340 may determine an action for a user interface of a target application through a rule-based approach. The action decision model 350 may determine an action for a user interface of a target application through a model-based approach. Through combining both the rule-based approach and the model-based approach for determining an action for a user interface of a target application, the coverage and integrity of automated testing may be improved in both depth and breadth.

The action decision model 350 may be a general action decision model, e.g., an action decision model suitable for various target applications. Additionally, a corresponding action decision model may be specially trained for a specific target application, so as to obtain an action decision model specific to the target application. Accordingly, the action decision model 350 may be an action decision model specific to the target application. The action decision model 350 may be selected from a general action decision model and an action decision model specific to the target application. Additionally, the action decision model 350 may be a public action decision model, e.g., an action decision model provided by an automated testing service. The action decision model 350 may also be a private action decision model, e.g., an action decision model previously saved by a user. The action decision model 350 may be selected from a public action decision model and a private action decision model. An automated testing service according to the embodiments of the present disclosure may present a user interface for selecting an action decision model to a user through a front end.

Preferably, the action decision model 350 may be pretrained through a teaching mode before the action decision model 350 is deployed for performing intelligent testing. In an implementation, a set of teaching actions may be set. Each teaching action of the set of teaching actions may have a high reward, e.g., a reward above a predetermined reward threshold. As described before, an action may be defined with an interface element and an operation mode corresponding to the interface element. An interface element corresponding to a teaching action may have a high operation probability. The action decision model 350 may be pretrained with the set of teaching actions and a set of rewards corresponding to the set of teaching actions. Training the action decision model 350 with such teaching actions will help the action decision model 350 learn what action can obtain a high reward, and thus, when deployed to perform intelligent testing, will be able to predict a high-quality action with a high reward. Teaching actions may be preset by the user. An automated testing service according to the embodiments of the present disclosure may present a user interface for providing teaching actions to a user through a front end. The user may provide, through the user interface, teaching actions for training the action decision model 350. Additionally, the action decision model 350 may be trained during use of the action decision model 350 to perform intelligent testing. The action decision model 350 may include an analyzing model 352 and a reward model 354. The analysis model 352 may predict an action for a user interface based on a user interface representation of the user interface generated by the user interface encoding model 320 and/or a scenario category of the user interface identified by the scenario classification model 330. The reward model 354 may calculate a reward corresponding to the action. The reward calculated by the reward model 354 may be used as feedback to further train the analyzing model 352 along with the action predicted by the analyzing model 352. An exemplary process for training an action decision model during performing an intelligent testing will be described later in conjunction with FIG. 4.

It should be appreciated that the intelligent testing performing unit 300 shown in FIG. 3 is merely an example of the intelligent testing performing unit. Depending on actual application requirements, the intelligent testing performing unit may have any other structure, and may include more or less components. For example, although in the above description, the action decision model 350 is a reinforcement learning model, in some embodiments, the action decision model 350 may also be other types of machine learning models. Accordingly, the action decision model 350 may be trained through other approaches.

FIG. 4 illustrates an exemplary process 400 for training an action decision model during performing an intelligent testing according to an embodiment of the present disclosure. An action decision model 430 may be trained through the process 400. The action decision model 430 may correspond to the action decision model 350 in FIG. 3.

A user interface 410 may be, e.g., a current user interface. A previous action 460 triggering the user interface 410 may be obtained. The previous action 460 may be previously predicted by the action decision model 430. For example, the previous action 460 may be previously predicted by the action decision model 430 for a previous user interface 420. A previous user interface representation 422 of the previous user interface 420 may be obtained, e.g., through a user interface encoding model. Herein, a user interface representation of a previous user interface may be referred to as a previous user interface representation. A previous scenario category 424 corresponding to the previous user interface 420 may be obtained, e.g., through a scenario classification model. Herein, a scenario category corresponding to a previous user interface may be referred to as a previous scenario category. The previous user interface representation 422 and/or the previous scenario category 424 may be provided to an analyzing model 440 in the action decision model 430. The analyzing model 440 may predict a previous action 460 for the previous user interface 420 based on the previous user interface representation 422 and/or the previous scenario category 424.

The previous action 460 may be applied to the previous user interface 420, thereby triggering a user interface 410.

A user interface representation 412 of the user interface 410 may be obtained, e.g., through a user interface encoding model. A scenario category 414 corresponding to the user interface 410 may be obtained, e.g., through a scenario classification model. The user interface representation 412 and/or the scenario category 414 may be provided to a reward model 450 in the action decision model 430. The reward model 450 may have a reward function 452. The reward function 452 may indicate a correspondence between an action and a reward. An action that triggers an abnormal user interface may have a first reward. For example, when an action is applied and the user interface crashes, the action may be considered to trigger an abnormal user interface. An action that triggers a normal and unexplored user interface may have a second reward. For example, when an action is applied and a previously unexplored or not occurred user interface presents, the action may be considered to trigger a normal and unexplored user interface. An action that triggers a normal and explored user interface may have a third reward. For example, when an action is applied and a previously explored or occurred user interface represents, the action may be considered to trigger a normal and explored user interface. Preferably, a specific value of the third reward may be determined based on the number of times the user interface occurs. An action that stalls a user interface may have a fourth reward. For example, when an action is applied but the user interface does not change, the action may be considered to stall the user interface. Values of the first reward, the second reward, the third reward and the fourth reward may decrease in sequence. That is, an action that triggers an abnormal user interface may have a highest reward. An action that triggers a normal and unexplored user interface may have a slightly lower reward. An action that trigger a normal and explored user interface may have a lower reward. An action that stalls a user interface may have a lowest reward. Such a reward function may enable the action decision model 430 to predict an action that enables the target application to present an abnormal or unexplored user interface, thereby as many different user interfaces as possible can be explored during the automated testing. This facilitates to improve the coverage of the automated testing, detect the stability of the target application, and enable problems of the target application to be exposed during the testing.

The reward model 450 may calculate a reward 454 corresponding to the previous action 460 based on the reward function 452 and the user interface representation 412 and/or the scenario category 414. For example, the reward model 450 may determine whether the previous action 460 triggers an abnormal user interface, a normal and unexplored user interface, or a normal and explored user interface, or stalls the user interface, etc., through comparing the user interface representation 412 and/or the scenario category 414 with the previous user interface representation 422 and/or the previous scenario category 424. Subsequently, the reward model 450 may calculate the reward 454 corresponding to the previous action 460 based on the determination and the reward function 452.

The action decision model 430 may be trained based on the previous action 460 and the reward 452, e.g., updating parameters in the analyzing model 440 in the action decision model 430. Optionally, the action decision model may be saved during or after performing the intelligent testing with the action decision model. For example, the action decision model may be saved at a local device of the user. The saved action decision model may be called and further trained during subsequent performing of intelligent testing.

It should be appreciated that the process for training the action decision model during performing the intelligent testing described above in conjunction with FIG. 4 is merely exemplary. Depending on actual application requirements, the steps in the process for training the action decision model may be replaced or modified in any manner, and the process may include more or fewer steps. For example, it is also possible to consider only the reward function 452 and the user interface representation 412 when calculating the reward 454 corresponding to the previous action 460.

Additionally, the specific order or hierarchy of the steps in the process 400 is merely exemplary, and the process for training the action decision model may be performed in an order different from the described one.

FIG. 5 illustrates an exemplary process 500 for automated testing based on intelligent exploration according to an embodiment of the present disclosure. The process 500 may be performed through, e.g., the intelligent testing performing unit 131-k in FIG. 1 or the intelligent testing performing unit 300 in FIG. 3. The automated testing based on intelligent exploration may be performed on a target application through the process 500.

At 502, a user interface of a target application may be obtained. The user interface may be, e.g., a current user interface of the target application.

Subsequently, a user interface representation of the user interface may be generated, and an action for the user interface may be determined based on the user interface representation.

For example, at 504, screen image and layout information of the user interface may be extracted. The screen image and the layout information of the user interface may be extracted through, e.g., the user interface data extracting module 310 in FIG. 3. The screen image of the user interface may be extracted through performing a screen capture operation on the user interface. The layout information of the user interface may include, e.g., a set of interface elements included in the user interface, a property of each interface element in the set of interface elements, etc. A property of an interface element may include, e.g., position, color, text content, operation mode, etc., of the interface element. An operation mode of an interface element may include, e.g., clicking, long pressing, typing, scrolling, etc.

At 506, a user interface representation of the user interface may be generated based on the extracted screen image and layout information. The user interface representation of the user interface may be generated e.g., based on the extracted screen image and layout information through the user interface encoding model 320 in FIG. 3. The user interface representation may include information related to the entire user interface as well as information related to individual interface elements on the user interface.

At 508, a scenario category corresponding to the user interface may be identified based on the generated user interface representation. A set of scenario categories may be predefined, and the set of scenario categories may include, e.g., a login scenario, a video playing scenario, an information filling scenario, a search scenario, a setting scenario, etc. A scenario category corresponding to the user interface may be identified from the set of predefined scenario categories based on the generated user interface representation, e.g., through the scenario classification model 330 in FIG. 3.

At 510, it may be determined whether there is a rule for the scenario category. For each scenario category in some scenario categories, a rule for the scenario category may be preset. The rule may include an action appropriate to the scenario category. For example, a rule for a login scenario, a search scenario, etc., may be preset.

If it is determined at 510 that there is a rule for the scenario category, the process 500 may proceed to 512 where an action corresponding to the rule is obtained. At 514, the obtained action may be determined as an action for the user interface. The action corresponding to the rule may be obtained e.g., through the rule application module 340 in FIG. 3, and the obtained action is determined as an action for the user interface.

If it is determined at 510 that there is no rule for the scenario category, an action for the user interface may be predicted based on the user interface representation and the scenario category.

The action may be predicted based on the user interface representation and the scenario category, e.g., through the action decision model 350 in FIG. 3. The user interface may include a set of interface elements. Each interface element may have a corresponding operation mode, e.g., clicking, long pressing, typing, scrolling, etc. The operation mode may be included in the layout information extracted through the step 504 and may be embodied in the user interface representation generated through the step 506. An interface element to be operated in the set of interface elements may be identified based on the user interface representation and the scenario category. For example, at 516, a set of operation probabilities corresponding to the set of interface elements may be generated based on the user interface representation and the scenario category. At 518, the interface element to be operated may be selected from the set of interface elements based on the set of operation probabilities. A probability of each interface element being selected may be proportional to the operation probability of the interface element. At 520, an action for the user interface may be defined with the interface element selected at 518 and the operation mode corresponding to the interface element.

The process 500 may proceed to a step 522 after the action for the user interface is determined through the steps 512-514, or the steps 516-520. At 522, the action for the user interface may be applied to the user interface to explore a next user interface, thereby an automated testing may be performed on the target application.

Subsequently, the process 500 may return to 502 and perform subsequent steps as described above. For example, a next user interface representation of a next user interface may be generated. A next action for the next user interface may be determined based on the next user interface representation. The next action may be applied to the next user interface. Through continuously determining and applying actions, the user interfaces of the target application can be explored, to identify bugs or fault existing in the target application. Preferably, the duration for performing the automated testing may be preset. When the expiration time for the duration is reached, the process 500 may end.

The automated testing based on intelligent exploration according to the embodiments of the present disclosure may perform automated testing on the target application without pre-compiling testing cases. Additionally, when the target application is updated or upgraded, there is no need to modify testing cases or testing programs even if the user interfaces change significantly. This may greatly improve the efficiency of automated testing. Furthermore, compared to perform automated testing by use of Monkey testing, the automated testing based on intelligent exploration may apply an action, to a user interface, suitable for the user interface based on understanding of the user interface, which facilitates implementing high-quality automated testing.

It should be appreciated that the process for automated testing based on intelligent exploration described above in conjunction with FIG. 5 is merely exemplary. Depending on actual application requirements, the steps in the process for automated testing based on intelligent exploration may be replaced or modified in any manner, and the process may include more or fewer steps. For example, at 504, both the screen image and the layout information of the user interface are extracted, and at 506, the user interface representation is generated based on both the screen image and the layout information, but in some embodiments, it is also possible to extract only one of the screen image and the layout information, and to generate the user interface representation based on only one of the screen image and the layout information. Additionally, at 516, the set of operation probabilities corresponding to the set of interface elements is generated based on both the user interface representation and the scenario category, but in some embodiments, it is also possible to generate a set of operation probabilities based on only one of the user interface representation and the scenario category. Furthermore, the specific order or hierarchy of the steps in the process 500 is merely exemplary, and the process for automated testing based on intelligent exploration may be performed in an order different from the described one.

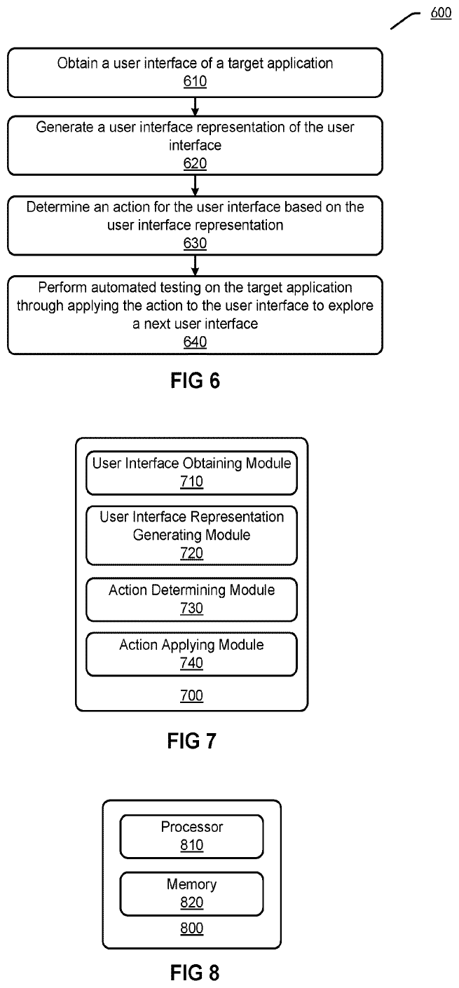

FIG. 6 is a flowchart of an exemplary method 600 for automated testing based on intelligent exploration according to an embodiment of the present disclosure.

At 610, a user interface of a target application may be obtained.

At 620, a user interface representation of the user interface may be generated.

At 630, an action for the user interface may be determined based on the user interface representation.

At 640, automated testing may be performed on the target application through applying the action to the user interface to explore a next user interface.

In an implementation, the generating a user interface representation may comprise: extracting screen image and/or layout information of the user interface; and generating the user interface representation based on the screen image and/or the layout information.

In an implementation, the determining an action may comprise: identifying a scenario category corresponding to the user interface based on the user interface representation; determining whether there is a rule for the scenario category; in response to determining that there is a rule for the scenario category, obtaining an action corresponding to the rule; and determining the obtained action as the action for the user interface.

The method 600 may further comprise: in response to determining that there is no rule for the scenario category, predicting the action based on the user interface representation and/or the scenario category.

The user interface may include a set of interface elements. Each interface element may have a corresponding operation mode. The predicting the action may comprise: identifying an interface element to be operated in the set of interface elements based on the user interface representation and/or the scenario category; and defining the action with the interface element and an operation mode corresponding to the interface element.

The identifying an interface element may comprise: generating a set of operation probabilities corresponding to the set of interface elements based on the user interface representation and/or the scenario category; and selecting the interface element to be operated from the set of interface elements based on the set of operation probabilities.

The predicting the action may comprise: predicting, through an action decision model, the action based on the user interface representation and/or the scenario category.

The action decision model may be a reinforcement learning model.

The action decision model may be selected from a general action decision model and an action decision model specific to the target application.

The action decision model may be selected from a public action decision model and a private action decision model.

The action decision model may be pretrained through: setting a set of teaching actions, each teaching action having a reward above a predetermined reward threshold; and pretraining the action decision model with the set of teaching actions and a set of rewards corresponding to the set of teaching actions.

The action decision model may be trained through: obtaining a previous action that triggered the user interface, the previous action was previously predicted by the action decision model;

computing a reward corresponding to the previous action based on a reward function and the user interface representation and/or the scenario category; and training the action decision model based on the previous action and the reward.

The reward function may indicate a correspondence between an action and a reward. The correspondence may include at least one of: an action that triggers an abnormal user interface has a first reward; an action that triggers a normal and unexplored user interface has a second reward; an action that trigger a normal and explored user interface has a third reward; and an action that stalls a user interface has a fourth reward. Values of the first reward, the second reward, the third reward and the fourth reward decrease in sequence.

In an implementation, the method 600 may further comprise: generating a next user interface representation of the next user interface; determining a next action for the next user interface based on the next user interface representation; and applying the next action to the next user interface. It should be appreciated that the method 600 may further comprise any step/process for automated testing based on intelligent exploration according to the embodiments of the present disclosure as mentioned above.

FIG. 7 illustrates an exemplary apparatus 700 for automated testing based on intelligent exploration according to an embodiment of the present disclosure.

The apparatus 700 may comprise: a user interface obtaining module 710, for obtaining a user interface of a target application; a user interface representation generating module 720, for generating a user interface representation of the user interface; an action determining module 730, for determining an action for the user interface based on the user interface representation; and an action applying module 740, for performing automated testing on the target application through applying the action to the user interface to explore a next user interface. Moreover, the apparatus 700 may further comprise any other modules configured for automated testing based on intelligent exploration according to the embodiments of the present disclosure as mentioned above.

FIG. 8 illustrates an exemplary apparatus 800 for automated testing based on intelligent exploration according to an embodiment of the present disclosure.

The apparatus 800 may comprise at least one processor 810 and a memory 820 storing computer-executable instructions. The computer-executable instructions, when executed, may cause the at least one processor 810 to: obtaining a user interface of a target application, generating a user interface representation of the user interface, determining an action for the user interface based on the user interface representation, and performing automated testing on the target application through applying the action to the user interface to explore a next user interface.

In an implementation, the determining an action may comprise: identifying a scenario category corresponding to the user interface based on the user interface representation; determining whether there is a rule for the scenario category; in response to determining that there is a rule for the scenario category, obtaining an action corresponding to the rule; and determining the obtained action as the action for the user interface.

The computer-executable instructions, when executed, may further cause the at least one processor 810 to: in response to determining that there is no rule for the scenario category, predicting the action based on the user interface representation and/or the scenario category.

The user interface may include a set of interface elements. Each interface element may have a corresponding operation mode. The predicting the action may comprise: identifying an interface element to be operated in the set of interface elements based on the user interface representation and/or the scenario category; and defining the action with the interface element and an operation mode corresponding to the interface element.

The identifying an interface element may comprise: generating a set of operation probabilities corresponding to the set of interface elements based on the user interface representation and/or the scenario category; and selecting the interface element to be operated from the set of interface elements based on the set of operation probabilities.

It should be appreciated that the processor 810 may further perform any other step/process of the method for automated testing based on intelligent exploration according to the embodiments of the present disclosure as mentioned above.

The embodiments of the present disclosure propose a computer program product for automated testing based on intelligent exploration, comprising a computer program that is executed by at least one processor for: obtaining a user interface of a target application; generating a user interface representation of the user interface; determining an action for the user interface based on the user interface representation; and performing automated testing on the target application through applying the action to the user interface to explore a next user interface. Additionally, the computer program may further be performed for implementing any other steps/processes of the method for automated testing based on intelligent exploration according to the embodiments of the present disclosure as mentioned above.

The embodiments of the present disclosure may be embodied in a non-transitory computer-readable medium. The non-transitory computer readable medium may comprise instructions that, when executed, cause one or more processors to perform any operation of the method for automated testing based on intelligent exploration according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for automated testing based on intelligent exploration, comprising:
obtaining a user interface of a target application;
generating a user interface representation of the user interface;
determining an action for the user interface based on the user interface representation; and
performing automated testing on the target application through applying the action to the user interface to explore a next user interface.

2. The method of claim 1, wherein the generating a user interface representation comprises:
extracting screen image and/or layout information of the user interface; and
generating the user interface representation based on the screen image and/or the layout information.

3. The method of claim 1, wherein the determining an action comprises:
identifying a scenario category corresponding to the user interface based on the user interface representation;
determining whether there is a rule for the scenario category;
in response to determining that there is a rule for the scenario category, obtaining an action corresponding to the rule; and
determining the obtained action as the action for the user interface.

4. The method of claim 3, further comprising:
in response to determining that there is no rule for the scenario category, predicting the action based on the user interface representation and/or the scenario category.

5. The method of claim 4, wherein the user interface includes a set of interface elements, each interface element having a corresponding operation mode, and the predicting the action comprises:
identifying an interface element to be operated in the set of interface elements based on the user interface representation and/or the scenario category; and
defining the action with the interface element and an operation mode corresponding to the interface element.

6. The method of claim 5, wherein the identifying an interface element comprises:
generating a set of operation probabilities corresponding to the set of interface elements based on the user interface representation and/or the scenario category; and
selecting the interface element to be operated from the set of interface elements based on the set of operation probabilities.

7. The method of claim 4, the predicting the action comprising:
predicting, through an action decision model, the action based on the user interface representation and/or the scenario category.

8. The method of claim 7, wherein the action decision model is a reinforcement learning model.

9. The method of claim 7, wherein the action decision model is selected from a general action decision model and an action decision model specific to the target application.

10. The method of claim 7, wherein the action decision model is selected from a public action decision model and a private action decision model.

11. The method of claim 7, wherein the action decision model is pretrained through:
setting a set of teaching actions, each teaching action having a reward above a predetermined reward threshold; and
pretraining the action decision model with the set of teaching actions and a set of rewards corresponding to the set of teaching actions.

12. The method of claim 7, wherein the action decision model is trained through:
obtaining a previous action that triggered the user interface, the previous action was previously predicted by the action decision model;
computing a reward corresponding to the previous action based on a reward function and the user interface representation and/or the scenario category; and
training the action decision model based on the previous action and the reward.

13. The method of claim 12, wherein the reward function indicates a correspondence between an action and a reward, and the correspondence includes at least one of:
an action that triggers an abnormal user interface has a first reward;
an action that triggers a normal and unexplored user interface has a second reward;
an action that trigger a normal and explored user interface has a third reward; and
an action that stalls a user interface has a fourth reward, and
wherein values of the first reward, the second reward, the third reward and the fourth reward decrease in sequence.

14. An apparatus for automated testing based on intelligent exploration, comprising:
at least one processor; and
a memory storing computer-executable instructions that, when executed, cause the at least one processor to:
obtain a user interface of a target application,
generate a user interface representation of the user interface,
determine an action for the user interface based on the user interface representation, and
perform automated testing on the target application through applying the action to the user interface to explore a next user interface.

15. A computer program product for automated testing based on intelligent exploration, comprising a computer program that is executed by at least one processor for:
obtaining a user interface of a target application;
generating a user interface representation of the user interface;
determining an action for the user interface based on the user interface representation; and
performing automated testing on the target application through applying the action to the user interface to explore a next user interface.
